(19) United States
(12) Patent Application Publication
(10) Pub. No.: US 2024/0404734 A1
(43) Pub. Date: Dec. 5, 2024

(54) TECHNIQUE FOR INSERTION OF A PROLATE OBJECT

(71) Applicant: Phoenix Contact GmbH & Co. KG, Blomberg (DE)

(72) Inventors: Juergen GRETSCHER, Dornhan (DE); Benjamin PRADEL, Lage (DE); Christian DALMER, Paderborn (DE); Marius SCHNEIDER, Villingen-Schwenningen (DE)

(21) Appl. No.: 18/697,745

(22) PCT Filed: Apr. 2, 2024
(86) PCT No.: PCT/EP2022/077192

§ 371 Date: Apr. 2, 2024

(30) Foreign Application Priority Data
Oct. 4, 2021 (BE) BE2021/5771

(51) Int. Cl. H01B 13/34; B41J 2/325; B41J 3/407; B41J 13/10

(52) U.S. Cl. CPC H01B 13/345; B41J 2/325; B41J 3/4073; B41J 13/106

(57) ABSTRACT

A device for insertion of a prolate object into a piece of tubing opened at least at an end for marking the prolate object includes: a guide corridor for conveying the piece of tubing along a longitudinal direction of the guide corridor, a width of the guide corridor in a transverse direction transverse to the longitudinal direction being controllable as a function of a diameter of the piece of tubing; and a support surface arranged downstream of the guide corridor in a conveying movement at least one position in the longitudinal direction, which support surface aligns the prolate object during insertion into the opened piece of tubing. The support surface includes at least two partial surfaces arranged one behind another in the longitudinal direction and overlapping in the transverse direction for supporting the prolate object during insertion.

### CROSS-REFERENCE TO PRIOR APPLICATIONS

This application is a U.S. National Phase application under 35 U.S.C. § 371 of International Application No. PCT/EP2022/077192, filed on Sep. 29, 2022, and claims benefit to Belgian Patent Application No. BE 2021/5771, filed on Oct. 4, 2021. The International Application was published in German on Apr. 13, 2023 as WO/2023/057316 under PCT Article 21(2).

### FIELD

The invention relates to a technique for marking a prolate object, for example a conductor. In particular, the invention relates to a device and a method for insertion of a prolate object, for example a conductor, into a piece of tubing opened at least at the end for marking the prolate object.

### BACKGROUND

For marking electrical conductors, for example, label printers are conventionally used which print a label which then has to be mounted on the conductor by manual work after printing. The document US 2003/146943 A1 describes a printer that alternately prints and cuts a label.

Special printers that may be used for conductor marking are also known. Document US 2004/0211522 A1 describes a machine that winds a pre-printed wrap-around label, provided on a spindle roll, around a conductor. Document US 2008/0073023 A1 describes a monolithic machine for printing and applying wrap-around labels.

However, conventional devices may only print certain labels and, if an automated application is integrated, no other printing applications are possible with such a device.

Conventionally, a user must manually insert the conductor to be marked into the device and check the position of the inserted conductor by eye. For example, a demonstration video published by the manufacturer “Brady” of the “Wraptor A6500” printer shows a manual insertion movement transverse to the longitudinal direction of the conductor, after which the label is wrapped around a position of the conductor determined by the device. The wrapping process is conventionally initiated manually or via a foot switch by the user.

The document WO 1999/56271 A1 describes the opening of a printed shrink tube in order to push it onto a conductor. However, with the conventional technique for opening, there is the possibility that the tube does not open when pressed using jaws on the longitudinal edges of the flattened tube, but instead an upper and a lower half of the tube buckle in the same direction.

Document WO 2021/069416 A1 describes a device which cuts off a printed shrink tube and opens it at least at the cut ends by deforming the shrink tube transversely to its longitudinal direction using opening rollers. The opening rollers are arranged on opposite sides of a guide corridor, the width of which is adjustable in that the opening rollers are mounted on transversely movable carriages.

Conventionally, the conductor is inserted manually by a user of the device, in particular over a fixed lower support edge, and the position of the inserted conductor is checked by eye. This limits the work cycle of marking a plurality of conductors in succession and thus productivity. In addition, visual inspection is strenuous and may be misjudged if the widths of the conductor and the shrink sleeve differ.

### SUMMARY

In an embodiment, the present invention provides a device for insertion of a prolate object into a piece of tubing opened at least at an end for marking the prolate object, the device comprising: a guide corridor configured to convey the piece of tubing along a longitudinal direction of the guide corridor, a width of the guide corridor in a transverse direction transverse to the longitudinal direction being controllable as a function of a diameter of the piece of tubing; and a support surface arranged downstream of the guide corridor in a conveying movement at least one position in the longitudinal direction, which support surface is configured for aligning the prolate object during insertion into the opened piece of tubing, wherein the support surface comprises at least two partial surfaces arranged one behind another in the longitudinal direction and overlapping in the transverse direction for supporting the prolate object during insertion.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a schematic embodiment of a device for insertion of a prolate object and for the circumferentially closed arrangement of a printed piece of tubing around the prolate object in a perspective view;

FIG. 2 a schematic embodiment of the device for the insertion of a prolate object and for the circumferentially closed arrangement of a printed piece of tubing around the prolate object in a sectional view transverse to the longitudinal direction of a guide corridor of the device:

FIG. 3 a schematic embodiment of the device for the insertion of a prolate object and for the circumferentially closed arrangement of a printed piece of tubing around the prolate object in a side view of the guide corridor of the device:

FIG. 4 a schematic embodiment of the device for the insertion of a prolate object and for the circumferentially closed arrangement of a printed piece of tubing around the prolate object in a plan view:

FIGS. 5A and 5B schematic views of a connection of the device for the insertion of a prolate object and for the circumferentially closed arrangement of a printed piece of tubing around the prolate object to a printer which provides the printed piece of tubing:

FIG. 6 a schematic embodiment of a device for insertion of a prolate object into a piece of tubing opened at least at the end for marking the prolate object in a perspective view:

FIG. 7 and FIG. 8 the schematic embodiment of the device for insertion of a prolate object into a piece of tubing opened at least at the end for marking the prolate object in a side view transverse to the longitudinal direction of a guide corridor of the device in various positions of a support surface:

FIG. 9 a first schematic embodiment of a support surface in a side view transverse to the longitudinal direction of a guide corridor of the device, wherein the support surface comprises at least two partial surfaces, wherein each partial surface comprises an inclined section with an absolute value of a slope:

FIGS. 10A, 10B and 10C a second schematic embodiment of a support surface in a side view transverse to the longitudinal direction of a guide corridor of the device, wherein the support surface comprises at least two partial surfaces, wherein each partial surface comprises two inclined sections with two different absolute values of a pitch:

FIGS. 11A, 11B and 11C a third schematic embodiment of a support surface in a side view transverse to the longitudinal direction of a guide corridor of the device when placing a prolate object on the support surface, wherein the support surface comprises at least two partial surfaces, each partial surface comprising at least two steps:

FIGS. 12A, 12B and 12C the third schematic embodiment of a support surface set for three different exemplary diameters of the prolate object; and

FIG. 13, FIG. 14 and FIG. 15 schematic embodiments of a support surface in a top view parallel to the longitudinal direction and to the transverse direction of a guide corridor, wherein the support surface comprises two, three or four partial surfaces.

### DETAILED DESCRIPTION

In an embodiment, the present invention provides a technique for the insertion of a prolate object into a piece of tubing which is opened at least at the end, wherein productivity may be increased and/or usage may be simplified. In an embodiment, the invention reproducibly positions the prolate object depending on a variable size of the piece of tubing and/or the prolate object (for example, to adjust or center it with respect to the piece of tubing opened at the end) for marking the prolate object.

Embodiments of the invention are described below with partial reference to the figures.

According to a first aspect, a device is provided for the insertion of a prolate object, preferably a conductor, into a piece of tubing (optionally printed and/or at least partially colored) opened at least at the end for marking the prolate object. The device comprises a guide corridor which is configured to convey the piece of tubing along a longitudinal direction of the guide corridor and optionally to open during the conveying movement (for example under the action of rolling forces). A width of the guide corridor can be controlled in a transverse direction transverse to the longitudinal direction depending on a diameter of the piece of tubing. The device further comprises a support surface arranged downstream of the guide corridor in the conveying movement at least one position in the longitudinal direction, which is configured to align the prolate object during insertion into the opened piece of tubing. The support surface comprises at least two partial surfaces arranged one behind the other in the longitudinal direction and overlapping in the transverse direction for supporting the prolate object during insertion.

The piece of tubing may be printed for marking, for example before or after insertion of the prolate object into the piece of tubing. Alternatively or additionally, the piece of tube may comprise a color marking, for example a color of the tube or a colored pattern (for example a colored stripe) of at least part of the piece of tube.

The piece of tubing (or flexible tubing or hose) may be separated (also: “cut off” or “separated”) from a long tubing (also: “endless tubing”) before the conveying movement and/or before opening. The long tubing may be provided wound on a spool. Alternatively or additionally, at least one length of the long tube comprising the piece of tubing may be unwound from the spool before printing and/or cutting.

A size of the piece of tubing (for example, variable from marking to marking) may be referred to as the diameter of the piece of tubing without limiting the generality. For example, the diameter may be an actual size, a nominal size or a nominal size of the piece of tubing.

For example, a width of the piece of tubing (i.e. a transverse dimension transverse to the longitudinal direction of the piece of tubing) in a cylindrical state of the piece of tubing may be equal or equivalent to the diameter. Alternatively or additionally, a width of the piece of tubing may be equal to or equivalent to the diameter in the state of the piece of tubing in which it is opened at least at the end. Alternatively or additionally, a width of the piece of tubing in the flat or flattened state of the piece of tubing may be equal to or equivalent to the diameter. In particular, the width of the piece of tubing in the different states may be equivalent except for a numerical factor (for example π/2 between the flat state and the cylindrical state).

The longitudinal direction of the guide corridor may coincide with a longitudinal direction of the piece of tubing and/or the prolate object.

The support surface may be configured to support the prolate object during insertion of the prolate object into the opened piece of tubing. Alternatively or additionally, the support surface may be arranged spatially in front of the piece of tubing at least one position in the longitudinal direction of the conveying movement.

The prolate object may be a conductor, a tube, a vessel or a housing. The conductor may be an elongated object for the line of signals or substances. For example, the conductor may be an elongated object for the line of electrical current and/or electromagnetic radiation (preferably light). The vessel may be a test tube or a sample tube, for example for holding and/or transporting a fluid.

The conductor may comprise one core or two, at least two, three or more cores that are electrically insulated or optically decoupled from each other. The cores may extend parallel to each other or be twisted together (for example in pairs).

The conductor may be a single, plurality of, fine and/or extra-fine stranded conductor. The conductor may be a cable, cable bundle and/or ribbon cable. The conductor may be a light guide (also: light guide cable). Alternatively or additionally, the conductor may be a tube and/or a fluid line.

The conductor may be a cylindrical body and/or a non-rotationally symmetrical, elongated body. The line of signals or substances may be directed along a longitudinal axis of the conductor and/or extend between ends of the conductor.

Embodiments of the device may increase a speed of marking the prolate object. Alternatively or additionally, embodiments of the device may enable serial marking of a plurality of prolate objects, in particular of variable widths. Further alternative or additional embodiments of the device may simplify marking of the prolate object.

The prolate object may comprise a conductor (e.g. electrical and/or optical). Alternatively or additionally, the prolate object may comprise a tube, for example a pneumatic tube and/or a hydraulic tube. Further alternatively or additionally, the prolate object may comprise a piecewise cylindrical object, for example a glass tube and/or an ampoule.

The marking may comprise a color of the piece of tubing (for example according to an identification color or a color code) and/or a printing on the piece of tubing (for example according to an alphanumeric identifier).

The (e.g. printed) piece of tubing for marking may be arranged or arrangeable in a circumferentially closed manner around the prolate object by insertion.

The piece of tubing may be opened in the device after printing for marking and/or cutting.

The prolate object may be inserted (also: “dipped”) into the (e.g. printed) piece of tubing, whereby the prolate object slides over the support surface in the longitudinal direction and is thus inserted into the opened end of the piece of tubing.

The support surface may be arranged spatially upstream of the piece of tubing in the longitudinal direction of the conveying movement of the piece of tubing. Alternatively or additionally, the support surface may be arranged downstream of the longitudinal direction of the conveying movement of the piece of tubing. Further alternatively or additionally, the prolate object may be inserted into the opened piece of tubing against the longitudinal direction of the conveying movement of the piece of tubing.

The insertion of the prolate object may comprise an alignment, for example an adjustment and/or (at least horizontal) centering, in particular with respect to the transverse direction and/or the width of the guide corridor.

The alignment, for example adjustment and/or centering, of the prolate object may comprise an alignment, for example adjustment and/or centering, in at least one transverse direction perpendicular to the longitudinal direction. Alternatively or additionally, the at least one transverse direction may comprise a (for example first) transverse direction that is parallel to the width of the guide corridor or is defined by the width of the guide corridor. Alternatively or additionally, the at least one transverse direction may comprise a (for example second) transverse direction (also: height) which is transverse (preferably perpendicular) to the width or the (for example first) transverse direction defined by the width of the guide corridor. Alternatively or additionally, the alignment, for example the adjustment and/or centering of the prolate object may comprise an alignment, for example an adjustment and/or centering, with respect to the width and/or the height of the guide corridor.

The width of the guide corridor may be determined by the diameter (also: width) of the piece of tubing. Alternatively or additionally, an (e.g. maximum) diameter (also: width) of the prolate object may be determined by the diameter of the piece of tubing and/or the width of the guide corridor.

Alternatively or additionally, the (e.g. minimum) diameter of the piece of tubing may be determined by a diameter (also: width) of the prolate object (e.g. to be marked). Alternatively or additionally, the width of the guide corridor may be determined by the diameter of the prolate object and/or the, in particular minimum, diameter of the piece of tubing.

The guide corridor may, for example, be formed by two rows of rollers (also: “opening rollers”) (e.g. arranged in a straight line and/or parallel to each other and/or each extending in the longitudinal direction). The conveying movement may comprise a co-rotating rotation of a first row of rollers about parallel axes of rotation. Furthermore, the conveying movement may comprise a co-rotating rotation of a second row of rollers about parallel axes of rotation. The parallel axes of rotation of the first row of rollers and the second row of rollers are parallel to each other. The rotational movement of the second row of rollers may be in the opposite direction to the rotational movement of the first row of rollers.

In each case, a roller of the first row and a roller of the second row (for example, opposite in the transverse direction) may be referred to as a pair of rollers, for example if the two rollers are arranged opposite each other in the guide corridor (for example, transverse to the longitudinal direction). The opposite position may comprise an equal position in the longitudinal direction.

The support surface may define a plane and/or a height of the guide of the prolate object, for example relative to a height of the guide corridor. Alternatively or additionally, the support surface may comprise (at least in part) a funnel. The funnel may be in two pieces (for example comprising two funnel halves) and/or arranged on either side of the guide corridor in the transverse direction. A tapered end of the funnel may project into a piece of tubing conveyed in the guide corridor (for example up to a stop point and/or end point of the conveying movement).

A height of the support surface perpendicular to the longitudinal direction and to the transverse direction may be dependent on the width of the guide corridor (for example, controlled). For example, a minimum height of the support surface extending in the transverse direction may be dependent on the width of the guide corridor (for example, controlled). Alternatively or additionally, a width and/or a height of an opening of the hopper may be dependent on the width of the guide corridor.

At least one partial surface of the support surface, and/or one half of the funnel, may be rigidly connected to one of two opposite sides of the guide corridor in the transverse direction.

A rigid connection may make the device particularly cost-saving and/or require little additional work in terms of providing the support surface and/or be particularly space-saving.

According to an embodiment, all partial surfaces and/or half of the hopper arranged on one of two opposite sides of the guide corridor may be rigidly connected to the side of the guide corridor. For example, the housing side of the device (100) on the first side of the guide corridor (for example, a cover of the rollers on the first side) and/or the at least one partial surface of the first side may be integrally one-piece (for example, manufactured using injection molding).

Alternatively or additionally, a subset of the subsurfaces may comprise two subsets of the subsurfaces, each arranged on one of the two opposite sides of the guide corridor. Each subset of the partial surfaces and/or each half of the funnel may be rigidly and/or mechanically (also: “kinematically”) connected to the respective side of the guide corridor in the transverse direction (for example with a transmission ratio, via a gear wheel and/or a control system).

The support surface may comprise at least three partial surfaces. A first partial surface and a third partial surface may be connected (for example rigidly) to a first side of the guide corridor (for example a first cover of the first row of rollers), for example rigidly and/or mechanically coupled (for example during motion in the transverse direction). Alternatively or additionally, a second partial surface arranged in the longitudinal direction between the first and third partial surfaces may be connected (for example rigidly) to a second side of the guide corridor opposite the first side (for example a second cover of the second row of rollers), for example rigidly and/or mechanically coupled (for example during motion in the transverse direction).

In other words, the support surface may comprise at least three partial surfaces (for example edges), which are arranged one behind the other in the longitudinal direction and are mechanically connected alternately to either the first side or the second side in the sequence of the arrangement.

The at least three partial surfaces (arranged, for example, in alternating orientation with respect to the opposite sides) may improve alignment, for example adjustment and/or centering, of the prolate object. In particular, an orientation of a longitudinal direction of the prolate object that deviates from the longitudinal direction of the guide corridor may be prevented.

The at least two partial surfaces of the support surface arranged one behind the other in the longitudinal direction may each comprise a concave curvature. Optionally, the concave curvature of the partial surfaces arranged on opposite sides of the guide corridor may be mirrored with respect to an axis perpendicular to the longitudinal direction and transverse direction.

The guide corridor may comprise a carriage movable in the transverse direction on at least one of two opposite sides of the guide corridor. Preferably, the guide corridor may comprise two carriages, each movable in opposite directions in the transverse direction, on the opposite sides of the guide corridor. Alternatively or additionally, the guide corridor may comprise a carriage movable in the transverse direction on a first side and be arranged immovably on a second side opposite the first side.

The diameter of the piece of tubing may be detected on the basis of a contact pressure of the at least one carriage and/or without contact (for example optically). Alternatively or additionally, the diameter of the piece of tubing may be transmitted by an upstream printer (also: “printing device”), a control system of the device and/or a control system of a system comprising the device. The upstream printer may be configured to print on the piece of tubing (for example before conveying in the guide corridor). The printer may be located upstream of the guide corridor in the conveying direction.

Optionally, the device may comprise a sensor for detecting (for example without contact) an object diameter of the prolate object. A height of the support surface may be controlled depending on the detected object diameter (optionally, and the width of the guide corridor), for example so that a longitudinal axis of the prolate object is coaxial with the longitudinal axis of the piece of tubing.

The device may comprise a control unit configured to perform a step of controlling described herein or to realize features described as controllable.

An overlapping union of the at least two partial surfaces arranged one behind the other in the longitudinal direction (which are each connected to one of the two opposite sides of the guide corridor, for example) may form a lower apex of the support surface (for example a local minimum height).

A slope of the partial surfaces (for example at the lower apex), curvature of the partial surfaces (for example at the lower apex), a height of the support surface and/or a height of the lower apex may be or comprise a (for example monotonic) function of the width of the guide corridor. For example, a height of the support surface (e.g. at the lower apex) may decrease with the width of the guide corridor. Alternatively or additionally, an opening of the funnel may increase with a width of the guide corridor.

The support surface may be arranged along the longitudinal direction at one end of the guide corridor.

The support surface may be arranged on one side of the housing of the device. The housing side may be arranged along the longitudinal direction at one end of the guide corridor. The housing side may comprise an opening for receiving the prolate object in the guide corridor.

The guide corridor may comprise side walls facing in the transverse direction on at least one section. The side walls may be profiled, for example concave on the side facing the piece of tubing. The side walls may be configured to open the (for example printed) piece of tubing (also: “print medium”) by compressing the piece of tubing in the transverse direction between the side walls.

Alternatively or additionally, the guide corridor may comprise (optionally profiled, for example waisted and/or concave) belts (also: “transport belts” or “pressure belts”) on opposite sides in the transverse direction. The belts may be configured to open (for example by compressing the piece of tubing in the transverse direction) and/or convey the (for example printed) piece of tubing (also: “print medium”).

Alternatively or additionally, the guide corridor may comprise profiled (in particular waisted and/or concave) rollers (also: “transport rollers” or “pressure rollers”) on opposite sides. The profiled rollers may be configured to open the (for example printed) piece of tubing (also: “print medium”) (for example by compressing the piece of tubing in the transverse direction and/or by flexing) and/or to convey it.

Alternatively or additionally, a surface of the profiled rollers may comprise at least smooth and/or structured (also: “rough”) partial surfaces. At least one structured partial surface of the profiled rollers may increase the friction of the piece of tubing in the guide corridor and/or improve the conveying of the piece of tubing in the guide corridor.

Sensors may be arranged along the longitudinal direction between the profiled rollers. The sensors may be configured to detect (e.g. determine and/or monitor) a position of the printed piece of tubing and/or the prolate object in the guide corridor.

The guide corridor may also comprise funnel-shaped half-forms (also: funnel halves) on opposite sides in the transverse direction. The funnel-shaped half-forms may taper in the longitudinal direction from the support surface in the direction of the guide corridor. For example, the funnel-shaped half-forms may taper towards insertion of the prolate object into the end opening of the piece of tubing and/or towards protruding into the end opening of the piece of tubing. Alternatively or additionally, a width of the funnel-shaped opening of the half-forms may be dependent on a width of the guide corridor.

The support surfaces, the partial surfaces, the funnel (for example the funnel-shaped half-forms) and/or the housing may be formed from a plastic and/or comprise a plastic.

The device may be arrangeable on a printer with a side facing away from the support surface along the longitudinal direction of the guide corridor. The printer may be configured to provide the printed piece of tubing (for example, to output it into the guide channel). Alternatively or additionally, the guide corridor may be arranged downstream of the printer (for example in terms of space and/or time) in the longitudinal direction of conveying the printed piece of tubing.

In a variant applicable to any feature and any embodiment, the device may be configured as an applicator, stem or attachment of a printer, in particular a thermal transfer printer. The device may be interchangeable with the printer. A plurality of different embodiments of the devices may each be optionally attachable to the same printer.

Embodiments of the device enable a modular system (also: printing system) that may be based on a single printer, for example a desktop device, so that this printer may be converted in a short time or in a few steps to different applications of marking one or a plurality of prolate objects, preferably a conductor. For example, a user may quickly and easily turn a normal or application-unspecific label printer into a system to assist in applying a marking (e.g. a label) to the prolate object to be marked, preferably a conductor to be marked.

The terms application and applying may (preferably as a process step) be synonymous or interchangeable herein. The terms arrangement and arranging may be synonymous or interchangeable herein (preferably as a method step).

Applying the marking on or to the prolate object (preferably on or to the conductor) may comprise arranging the marking on or to the prolate object. Providing the marking, which is arranged or arrangeable in a closed manner around the prolate object (preferably around the conductor), may comprise cutting (preferably trimming) the printed product (for example the printed piece of tubing).

According to a second aspect, a system is provided for inserting a prolate object, preferably a conductor, into a piece of tubing, which is opened at least at the end, in particular printed, for marking the prolate object. The system comprises a printer, preferably a thermal transfer printer, which is configured to output a printed piece of tubing as a printed product. The system further comprises a device according to the first aspect, wherein the guide corridor is arranged relative to the printer to receive the printed piece of tubing output by the printer as a printed product.

A print medium of the printer may be a piece of tubing. A length of the piece of tubing as the print medium may be any length or several times longer than the provided printed piece of tubing as the marking. The print medium may be an endless tube. The printed piece of tubing output by the printer may also be referred to as a printed product. The printed product of the printer may comprise the printed piece of tubing. The (printed) marking may comprise the cut and opened printed piece of tubing.

The printer may receive an identifier (also: “print template”, for example comprising text and/or image information) via an interface (e.g. a network interface or a serial interface). The printer may be configured to print the received identifier onto a print medium using a printing material. The printing material may comprise a color ribbon, for example for thermal transfer printing. The print medium (i.e. a substrate or printing material) may be a plastic film, for example for heat sealing or welding, or a shrink tube. The printed product (for example, the printed piece of tubing) may comprise the print medium printed using the printing material. The printed identification may also be referred to as marking. Alternatively or additionally, the printed identifier may comprise a color coding, a pictogram, a character, a symbol and/or an encoding (e.g. a QR code and/or a barcode).

The printer may be a thermal transfer printer. The thermal transfer printer may enable high-contrast and durable marking. For example, the printer may be a thermal transfer roll printer.

One end of the guide corridor may be arranged at an output point of the print medium.

By attaching embodiments of the device for a specific application to a printer that is not specific to the application, special printers for the respective application, and thus costs, may be avoided and/or resources may be used more effectively. For example, this may increase the degree of utilization of the printer. The same or further embodiments of the device may reduce downstream manual effort when mounting the printing materials on the objects to be marked.

According to a third aspect, there is provided a method for insertion of a prolate object, preferably a conductor, in a piece of tubing opened at least at one end, in particular printed, for marking the prolate object. The method comprises controlling a width in a transverse direction transverse to a longitudinal direction of a guide corridor as a function of a diameter of the piece of tubing. The method further comprises conveying the piece of tubing in the longitudinal direction of the guide corridor, and optionally opening at least one end of the piece of tubing on the conveying direction side (for example under the action of rolling forces). The method further comprises placing the prolate object on a support surface arranged downstream of the guide corridor in the conveying movement at least one position in the longitudinal direction. Alternatively or additionally, the support surface may be arranged upstream of the piece of tubing at least one position in the longitudinal direction of the conveying movement. The support surface comprises at least two partial surfaces arranged one behind the other in the longitudinal direction and overlapping in the transverse direction for supporting the prolate object during insertion. The device further comprises an insertion of the prolate object into the end of the piece of tubing on the conveying direction side along the support surface.

The method of the third aspect may be carried out using the device of the first aspect and/or the system of the second aspect.

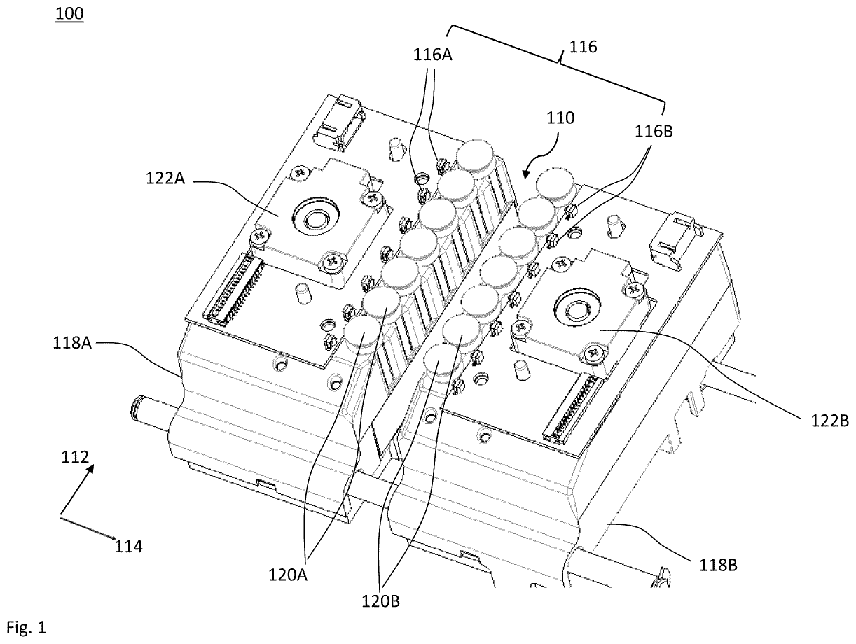

FIGS. 1, 2, 3 and 4 show schematic views of an embodiment of a device (also: “applicator”) generally designated by reference numeral 100 for insertion of a prolate object (also: “medium”) into a piece of tubing (also: “shrink tube”), which is opened at least at the end, in particular printed, for marking the prolate object. The marking may comprise a circumferentially closed arrangement of the, in particular printed, piece of tubing around the prolate object.

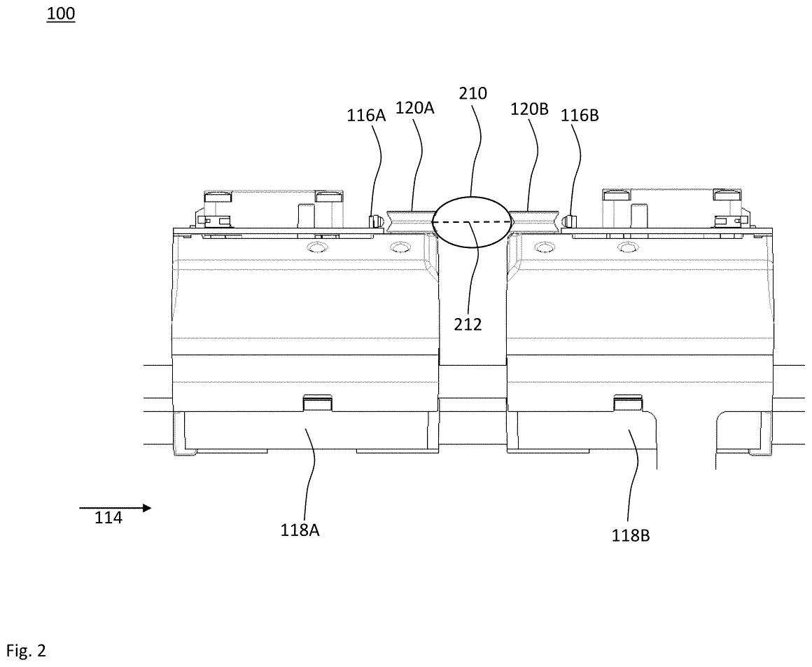

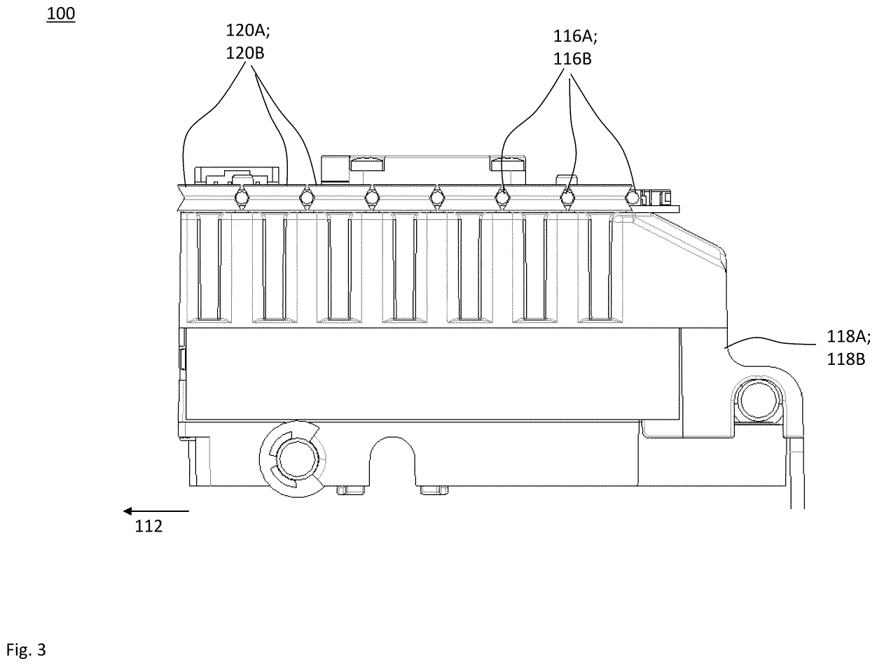

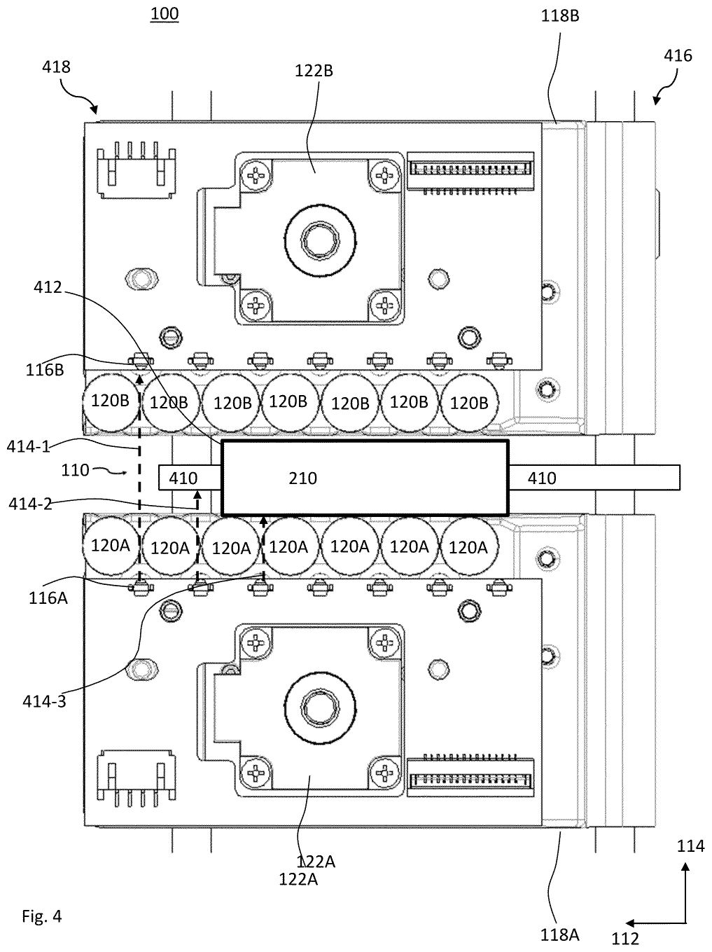

FIG. 1 shows a perspective view of the embodiment of the device 100. FIG. 2 shows a sectional view of the embodiment of the device 100 transverse to the longitudinal axis of a guide corridor of the device 100 with a piece of tubing conveyed in the guide corridor. FIG. 3 shows a side view along the guide corridor. FIG. 4 shows a top view of the embodiment of the device 100 with a piece of tubing conveyed in the guide corridor and an inserted prolate object, for example a conductor.

The embodiment of the device 100 shown in FIG. 1 comprises a first carriage 118A (also: “slider”) and a second carriage 118B (also: “slider”), between which a guide corridor 110 is configured with longitudinal direction 112 and transverse direction 114. Along the longitudinal direction 112 of the guide corridor 110, a first row of rollers 120A (also: “opening rollers”) is arranged on the first carriage 118A. Furthermore, a second row of rollers 120B (also: “opening rollers”) is arranged along the guide corridor 110 on the second carriage 118B. In the longitudinal direction 112, a row of transmitters 116A, for example transmitting diodes of a light barrier, of a sensor 116 may optionally be arranged between neighboring rollers 120A on the first carriage 118A. In the longitudinal direction 112, a row of receivers 116B, for example receiving diodes of a light barrier, of a sensor 116 may optionally be arranged between adjacent rollers 120B on the second carriage 118B.

In the embodiment of FIG. 1, the rollers 120A; 120B are each waisted. Opposite pairs of transmitters 116A and receivers 116B may be connectable along the transverse direction 114 between pairs of rollers 120A; 120B adjacent along the longitudinal direction 112 (for example, along a line of sight). A pair of rollers 120A; 120B in the embodiment comprises a respective roller 120A and the roller 120B opposite to it along the transverse direction 114.

In the embodiment of FIG. 1, the transmitters 116A on the first carriage 118A may be connected to a transmitter board 122A. The receivers 116B on the second carriage 118B may be connected to a receiver board 122B on the second carriage 118B.

A sensor system may comprise sensors 116 and transmitter circuit board 122A and receiver circuit board 122B, which may also be referred to as opposing circuit boards. In one embodiment, the transmitting board 122A may be an infrared light (IR) transmitting source. The receiving board 122B may comprise receiving electronics and/or evaluation electronics.

In the embodiment shown in FIG. 1, the transmitter board 122A and the receiver board 122B may be mechanically positioned on the movable carriages 118A; 118B, between which a printed piece of tubing may be opened.

In the embodiment of FIGS. 1 and 2, the rollers 120A and/or 120B convey the piece of tubing 210 along the guide corridor 110. Rolling forces of the rollers 120A; 120B open the piece of tubing, for example if the piece of tubing 210 has been closed during printing or cutting (for example at one or both ends).

The (for example opened end of the) piece of tubing 210 may approximately comprise an oval shape and/or a lemon shape, for example with pointed ends at the rollers 120A; 120B. Alternatively or additionally, the (for example opened end of the) piece of tubing 210 may correspond to the outline of a convex lens.

A maximum diameter of the prolate object may be limited by the deviation of the (for example, opened end of the) piece of tubing 210 (for example, a heat shrinkable tube and/or heat shrinkable piece of tubing) from a circular shape. For example, a width and/or a diameter of the piece of tubing 210 may be nominally specified in circular form, in particular as a wire marking slide (WMS) dimension (for example for sliding application of the piece of tubing around the prolate object) and/or in millimeters (mm). A maximum diameter of a prolate object insertable into the piece of tubing 210 may be smaller than the WMS dimension of the piece of tubing by a fixed unit of length, for example by a fraction of a millimeter (in particular by 0.8 mm).

The sectional view of FIG. 2 shows a cross-sectional view of the embodiment of the device 100 along the transverse direction 114. The transmitter 116A and receiver 118A may be arranged along the transverse direction 114 offset from the (for example waisted) rollers 120A and 120B. Along the longitudinal direction 112 (not shown in FIG. 1), transmitter 116A and receiver 116B may be arranged between adjacent pairs of rollers 120A and 120B such that a line of sight 212 is unobstructed between transmitter 116A and receiver 116B.

In other words, a mechanical feature of the arrangement of the device 100 may be that the transmitter 116A and receiver 116B (for example, a transmitting diode or a receiving diode or phototransistor of a sensor 116) may virtually “see through” the opening rollers to detect the piece of tubing and the prolate object passing through (for example, when the sensor 116 is blocked).

FIG. 3 shows the embodiment of the device 100 of FIGS. 1 and 2 in a side view along the longitudinal direction 112 of the guide corridor. For example, FIG. 3 shows a side view of the first carriage 118A and/or the second carriage 118B, wherein the respectively shown side of the carriage 118A; 118B forms one side of the guide corridor 110.

FIG. 4 shows a top view of the embodiment of the device 100 of FIGS. 1 to 3. FIG. 4 further shows a piece of tubing 210 and an inserted prolate object 410. In the embodiment, the piece of tubing 210 is provided by a printer (for example a thermal transfer printer) arranged at a printer side 418 and conveyed into the guide corridor 110. The prolate object 410 is inserted into the piece of tubing 210 from a user side 416 opposite the printer side 418. A first light beam 414-1 and a second light beam 414-2 from adjacent emitters 116A on the printer side 418 may be released from a trailing end 412 of the tubular member 210 during or after the conveying process of the tubular member 210. A third light beam 414-3 of a third transmitter 116A may be blocked by the piece of tubing 210 during or after the conveying process of the piece of tubing 210. An exit of the prolate object 410 at the trailing end 412 of the piece of tubing 210 may be detected by the blocking of the second light beam 414-2. Each light beam 414-1, 414-2, 414-3 may be directed along a line of sight 212 of the associated sensor 116, each comprising a transmitter 116A and a receiver 116B.

That the piece of tubing 210 may reach a forward position (for example, relative to the user side 416) during the conveying process. The prolate object 410

may be inserted into the guide corridor 110 and the piece of tubing 210 after reaching the front position of the piece of tubing 210.

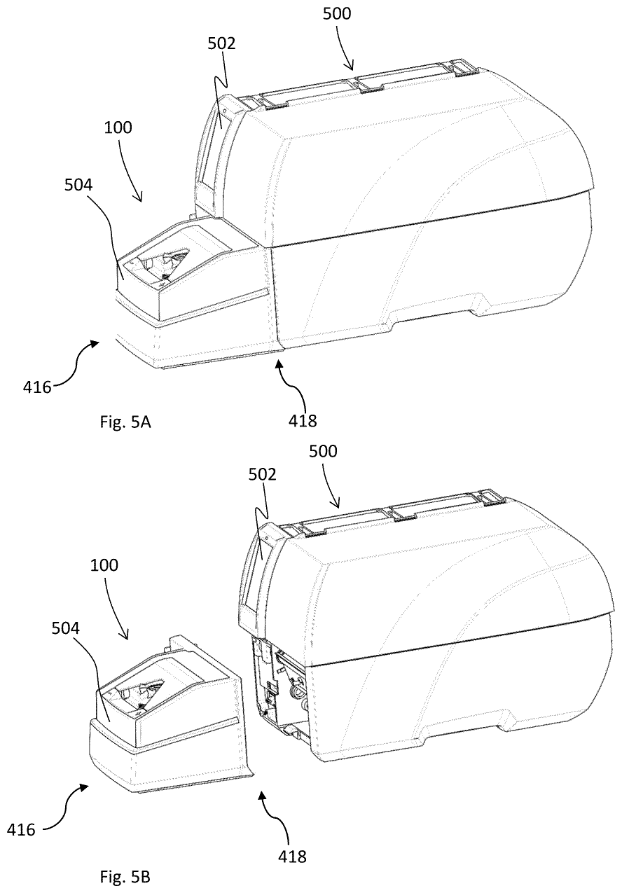

FIGS. 5A and 5B show an arrangement of the device 100 for insertion of a prolate object 410 into a piece of tubing 210, which is opened on at least one side, in particular printed, for marking the prolate object 410 on a printer 500.

In FIG. 5A, the device 100 is connected to the printer 500 for receiving the printed piece of tubing 201 via the printer side 418 of the device 100. The prolate object 410 is insertable into the device 100 via the user side 416 of the device 100.

FIG. 5B shows an exploded view of the system comprising the device 100 and the printer 500 in an unconnected state of the device 100 and the printer 500. In FIGS. 5A and 5B, the device 100 is shown in a housing 504.

The system may comprise a mechanical interface configured to removably mount the device 100 to the printer 500. Alternatively or additionally, the device 100 comprises a data interface configured to communicate with the printer 500 for providing (for example, applying) the printed, cut and opened piece of tubing 210 as a marking.

In the embodiment shown in FIGS. 5A and 5B, the printer 500 comprises a display 502. For example, the display 502 may display a width, a state and/or a position of the printed tubular object 210 (for example in the device 100). Alternatively or additionally, a width and/or a position of the prolate object 410 in the device 100 may be displayed on the display 502.

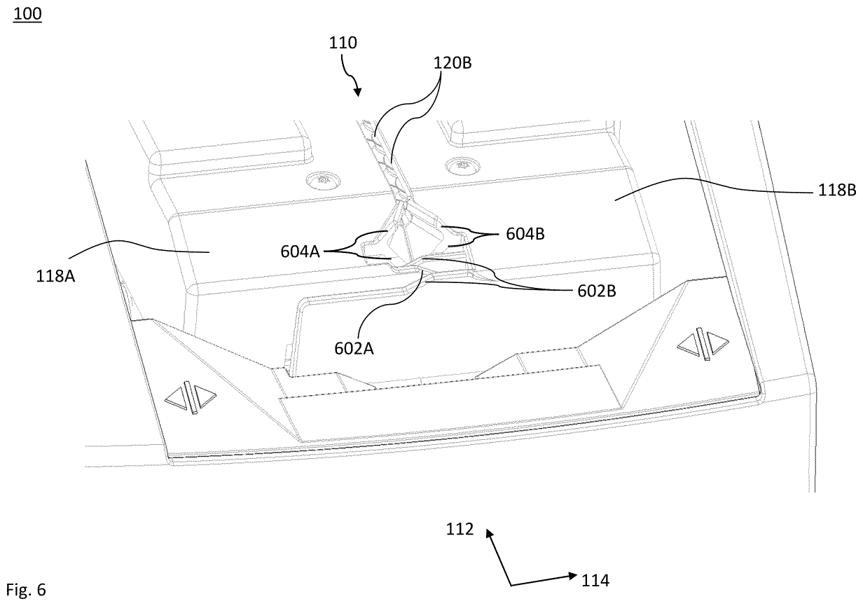

FIG. 6 shows a further perspective view of a schematic embodiment of a device 100 for inserting a prolate object 410 into a piece of tubing 210 which is opened on at least one side, in particular a printed piece of tubing 210 for marking the prolate object 410. The device 100 may also be referred to as an automatically adjusted insertion aid.

The device 100 and/or the system 500 may open a piece of tubing (also: shrink tubing) at least at the end, for example after printing and/or cutting, and make it available for insertion of a prolate object for marking. The prolate object may comprise any medium to be labeled (e.g. cables, pneumatic tubes, glass fibers, etc.).

Conventionally, a user either threads the prolate object into the piece of tubing freehand, or sights the prolate object over a rigid support edge. With conventional rigid supports, it is necessary to manually (also: manually) adjust a height to different diameters (for example of the prolate object 410 and/or the piece of tubing 210).

In the embodiment according to the invention shown in FIG. 6, a support surface comprises a plurality of (in particular three) partial surfaces 602A 602B, which are arranged on opposite sides of the guide corridor 110, for example each on a movable carriage 118A 118B.

The embodiment according to the invention shown in FIG. 6 further comprises a funnel comprising two funnel-shaped half-forms 604A; 604B (also: funnel halves) arranged on opposite sides of the guide corridor 110. For example, one half 604A of the funnel is arranged on the first carriage 118A and a second half 604B of the funnel is arranged on the second carriage 118B.

Using the device 100, a dynamic support aid and/or insertion aid for a prolate object may be provided, which in particular automatically adapts to the respective tube diameters to be applied.

In the embodiment shown in FIG. 6, two carriages (also: sliders) 118A; 118B may open and close, for example linearly. As a result, a width of the guide corridor 110 may be changed, in particular increased or reduced.

The partial surfaces 602A; 602B of the support surface adjust themselves (for example when the carriages 118A; 118B are moved) to a width of the guide corridor 110, a width of the piece of tubing and/or a (for example maximum) width of the prolate object. For example, a small width of the guide corridor 110 corresponds to a high height of the support surface. Alternatively or additionally, a large width of the guide corridor 110 corresponds to a low height of the support surface.

In the embodiment shown in FIG. 6, a distance between the funnel halves 604A; 604B also changes with the width of the guide corridor 110.

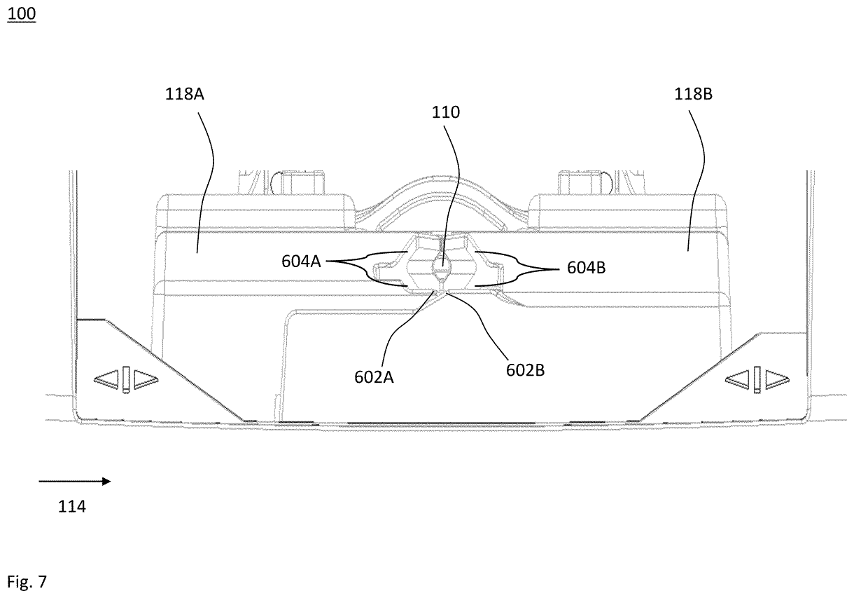

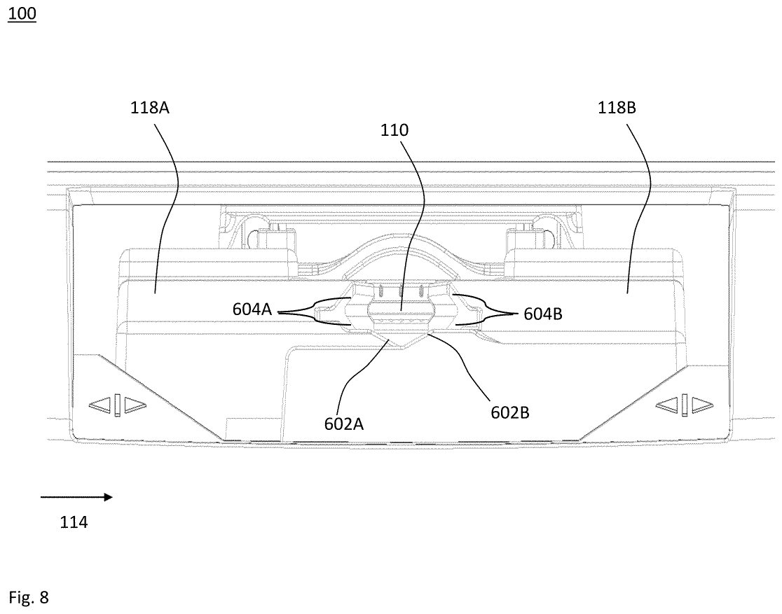

FIG. 7 and FIG. 8 show a side view of the device 100 of the embodiment of FIG. 6 with different positions of the hopper halves 604A; 604B.

In the position shown in FIG. 7, the carriages 118A; 118B are moved close together. The width of the guide corridor 110 is small, and the hopper halves 604A; 604B are arranged close together. The partial surfaces 602A; 602B provide a large height of the support surface.

A small diameter prolate object resting on the partial surfaces 602A; 602B may initially be arranged below the height of the guide corridor 110 and be inserted upwards towards the guide corridor 110 and into the piece of tubing arranged behind the funnel halves 604A; 604B using the funnel halves 604A; 604B.

In the position shown in FIG. 8, the carriages 118A; 118B are moved far apart. The width of the guide corridor 110 is large, and the hopper halves 604A; 604B are far apart. The partial surfaces 602A; 602B provide a low support surface height.

A large diameter prolate object resting on the partial surfaces 602A; 602B may be arranged substantially at the level of the guide corridor 110. Alternatively or additionally, the prolate object may be inserted, in particular slightly, upwards towards the guide corridor 110 using the funnel halves 604A; 604B and into the piece of tubing arranged behind the funnel halves 604A; 604B.

In the embodiment shown in FIG. 6, FIG. 7 and FIG. 8, the at least one partial surface 602A and the hopper half 604A are rigidly arranged on the first carriage 118A. In FIGS. 6, 7 and 8, the at least one partial surface 602B and the funnel half 604B are rigidly arranged on the second carriage 118B.

In a further embodiment, the partial surfaces 602A; 602B and/or the hopper halves 604A; 604B may only be adjusted indirectly depending on the change in width of the guide corridor 110 (for example due to a motion of the carriages 118A; 118B). For example, the partial surfaces 602A; 602B and/or the hopper surfaces 604A; 604B may be adjusted using a motor.

The partial surfaces 602A; 602B and/or funnel halves 604A; 604B may automatically adjust to the correct diameter (for example, of the guide corridor 110, the piece of tubing 210 and/or the prolate object 410).

A V-cutout of the partial surfaces 602A; 602B and/or a V-cutout of the funnel halves 604A; 604B may be pronounced such that the height matches the diameter (for example approached and/or set by the carriages 118A; 118B) of, for example, the guide corridor 110, the piece of tubing 210 and/or the prolate object 410).

The geometry and/or cover of conventional carriages (also known as sliders) may be modified for this purpose. The position of the carriages relative to each other is conventionally dependent on the diameter of the piece of tubing to be applied. This may be used to “automatically” achieve the correct height of the support surface (in particular comprising the partial surfaces 602A; 602B) and/or opening width of the funnel (in particular comprising the funnel halves 604A; 604B).

The automatic readjustment and/or dynamic adjustment of the height of the support surface (in particular comprising the partial surfaces 602A; 602B) and/or the opening width of the hopper (in particular comprising the hopper halves 604A; 604B) may be performed by an already necessary and/or existing (for example relative) motion of two components (in particular the carriages 118A; 118B).

In particular, if the partial surfaces 602A; 602B and/or the hopper halves 604A; 604B are rigidly arranged on opposite sides of the guide corridor 110 (for example comprising carriages 118A and 118B), no additional drive and/or no separate adjustment is necessary.

In one embodiment, only two existing plastic covers in particular may be modified. This means that there are practically no additional costs for material and assembly due to the insertion aid according to the invention.

The maximum diameter of the insertable prolate object (for example a conductor and/or for example comprising a conductor diameter between 1 mm and 15 mm) may be smaller by a fixed value (for example 0.8 mm) than the diameter (for example the WMS value and/or for example a diameter between 1 mm and 15 mm) of the piece of tubing, for example because the latter is not opened to a perfect circular cross-section (but for example oval and/or lemon-shaped).

If there is a small difference between the diameter of the prolate object and the opened piece of tubing, insertion may be more difficult. For example, greater accuracy and/or more precise alignment of a wide prolate object may be required when inserting it into the opened piece of tubing than when inserting a narrow prolate object in order to avoid missing, or partially missing, the opening of the piece of tubing.

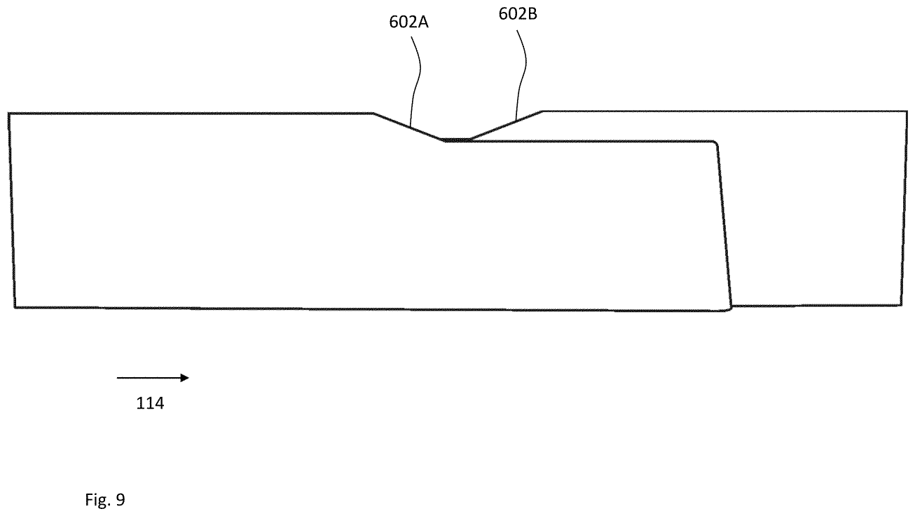

FIG. 9 shows a first embodiment of a basic shape of at least two partial surfaces 602A and 602B of a support surface. The partial surfaces 602A; 602B of the embodiment of FIG. 9 each comprise a slope with a fixed absolute value of the slope, wherein the slopes of the partial surfaces 602B are mirrored with respect to the slopes of the partial surfaces 602A (and/or comprise a reversed sign).

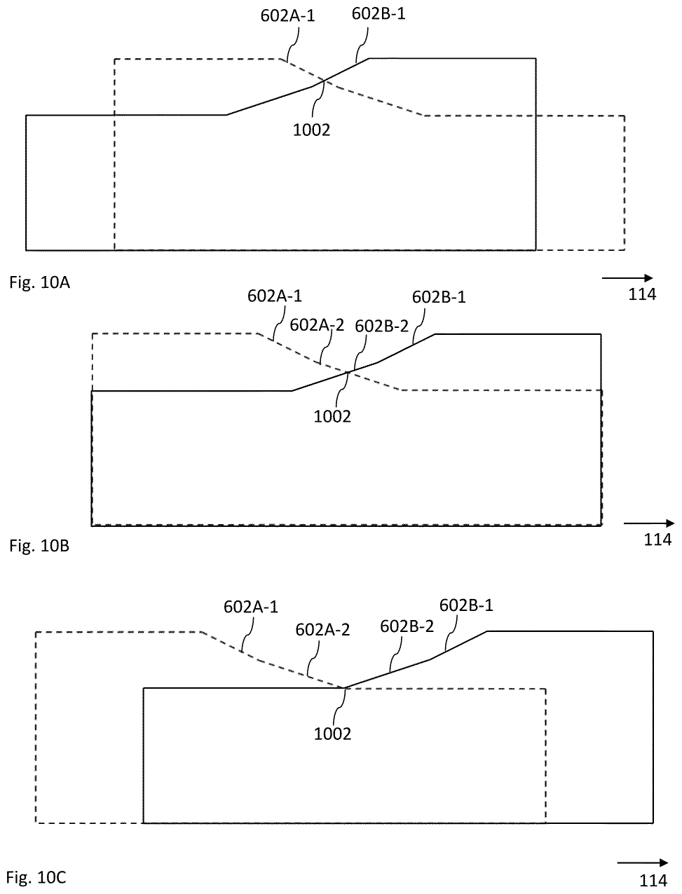

FIGS. 10A, 10B and 10C show a second embodiment of a basic shape of at least two partial surfaces 602A and 602B of a support surface. The partial surfaces 602A; 602B of the embodiment of FIGS. 10A, 10B and 10C each comprise two different slopes 602A-1; 602A-2; 602B-1; 602-B2 with fixed absolute values of the slopes, wherein the slopes of the partial surfaces 602B-1; 602B-2 are mirrored with respect to the slopes of the partial surfaces 602A-1; 602A-2 (and/or comprise a reversed sign).

In FIG. 10A, the two partial surfaces 602A; 602B are moved close together. Alternatively or additionally, a prolate object may be placed and inserted at the first inclinations 602A-1; 602B-1. In the position of the partial surfaces 602A; 602B of FIG. 10A, a height support surface (for example parameterized by a height of the apex 1002) may be large.

In FIG. 10B, the two partial surfaces 602A; 602B are moved together into a middle position. Alternatively or additionally, a prolate object may be applied and inserted at the (for example middle points of the) second inclinations 602A-2; 602B-2. In the position of the partial surfaces 602A; 602B of FIG. 10B, a height of support surface (for example parameterized by a height of the apex 1002) may be intermediate.

In FIG. 10C, the two partial surfaces 602A; 602B are moved wide apart. Alternatively or additionally, a prolate object may be placed and inserted at the (for example lower points of the) second inclinations 602A-2; 602B-2. In the position of the partial surfaces 602A; 602B of FIG. 10C, a height support surface (for example parameterized by a height of the apex 1002) may be low.

In an alternative embodiment, one, such as a second, inclination (e.g., 602A-2; 602B-2 in FIG. 10B or 10C) may be adjusted by a predetermined angle, such as two degrees (2°). For example, the partial surface 602A-2 (or 602B-2) may be deflected relative to the partial surface 602A-1 (or 602B-1) using a spring-loaded hinge. Alternatively or additionally, an inclination of the partial surfaces 602A-2; 602B-2 may deviate from a parallel position of the partial surfaces 602A-2; 602B-2.

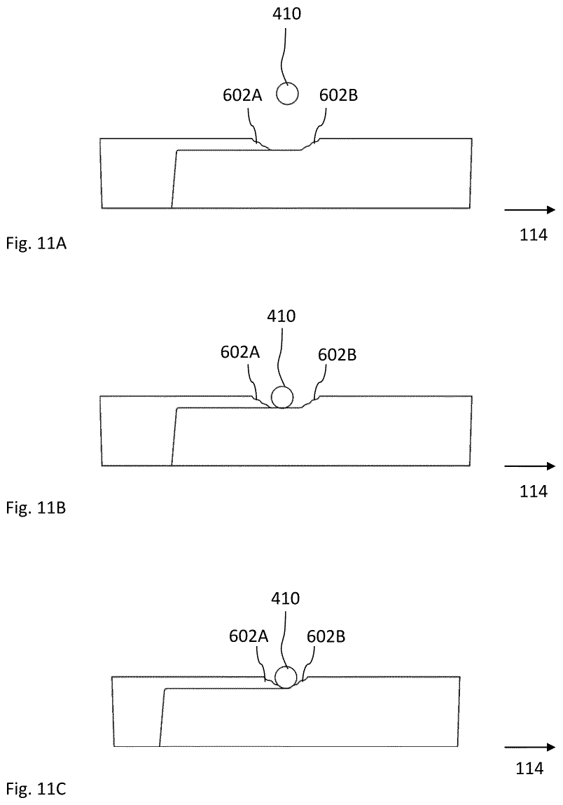

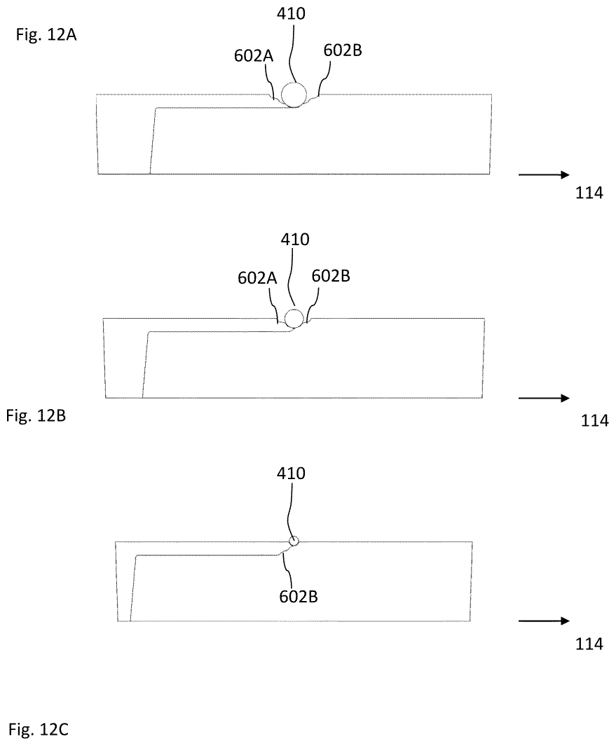

FIGS. 11A, 11B and 11C and FIGS. 12A, 12B and 12C show a third embodiment of a basic shape of at least two partial surfaces 602A; 602B. In the embodiment of FIGS. 11A, 11B and 11C, each partial surface 602A or 602B comprises a stepped shape.

In FIGS. 11A, 11B and 11C, a possible process of the method, in particular an insertion of a prolate object 410, is shown schematically. In FIG. 11A, the partial surfaces 602A; 602B are moved far apart. When the prolate object 410 is placed in FIG. 11B, the partial surfaces 602A; 602B are moved together until an end position is reached in FIG. 11C, which depends on a desired width of the guide corridor and/or the piece of tubing.

FIGS. 12A, 12B and 12C show various collapsed end positions of the partial surfaces 602A; 602B as a function of a width (and/or a diameter and/or cross-section) of the prolate object 410 and/or a width (and/or a diameter and/or cross-section) of the piece of tubing, wherein the width of the prolate object decreases steadily from FIG. 12A to FIG. 12C. For example, in each case, a minimum width (and/or diameter) of a piece of tubing may be selected for marking a predetermined prolate object 410.

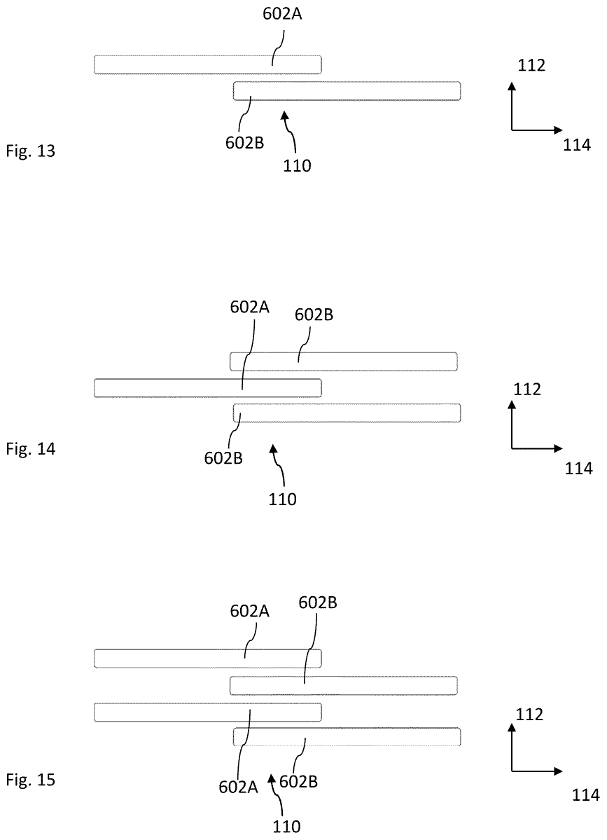

FIG. 13 shows an embodiment of an arrangement comprising two partial surfaces 602A; 602B in a top view (for example of the device 100).

FIG. 14 shows an alternative embodiment of an alternating arrangement comprising three partial surfaces 602A; 602B in a top view (for example of the device 100).

FIG. 15 shows a further alternative embodiment of an alternating arrangement comprising four partial surfaces 602A; 602B in a top view (for example of the device 100).

An arrangement of the at least two partial surfaces 602A; 602B may also be referred to as “combing”.

Further embodiments of arrangements of partial surfaces 602A; 602B may comprise partial surfaces 602A and 602B alternately originating from one side and the opposite side of the guide corridor 110, respectively. In particular, the number of subareas 602A and 602B may either be the same or may differ by one subarea (for example at one end of the arrangement, as in the embodiment of FIG. 14).

As can be seen based on the above embodiments, a longitudinal guidance of the prolate object 410, for example a conductor, may be improved by a support on at least three partial surfaces 602A; 602B arranged alternately in the longitudinal direction 112 (for example according to FIG. 14 or FIG. 15). Alternatively or additionally, a guide in a funnel, for example following in the longitudinal direction, improves both a longitudinal guide and a guide at a height transverse to the longitudinal direction 112 and transverse to the transverse direction 114. For example, the prolate object 410 may slide upwardly along the funnel for insertion into the tubular member 210.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Device 100
Guide corridor 110
Longitudinal direction 112
Transverse direction 114
Sensor 116
Transmitter of the sensor 116A
Receiver of the sensor 116B
First slide 118A
Second slide 118B
Rollers on the first slide 120A
Rollers on the second carriage 120B
Transmitter board 122A
Receiver board 122B
Tubing section 210
Visual axis 212
Prolate object, for example ladder 410
Trailing end of the tubing section 412
Light beams 414-1; 414-2; 414-3
User page of the device 416
Printer side of the device 418
Printer, for example thermal transfer printer 500
Display, preferably user interface, of the printer 502
Housing of the device 504
Partial surface of the support surface on the first slide 602A
First bevel of the partial surface of the support surface
on the first slide 602A-1
Second bevel of the partial surface of the support surface
on the first slide 602A-2
Partial surface of the support surface on the second slide 602B
First slope of the partial surface of the support surface
on the second slide 602B-1
Second bevel of the partial surface of the support surface
on the second slide 602AB-2
Hopper half on the first slide 604A
Hopper half on the second slide 604B
Vertex of overlapping subareas 1002

1. A device for insertion of a prolate object into a piece of tubing opened at least at an end for marking the prolate object, the device comprising:
a guide corridor configured to convey the piece of tubing along a longitudinal direction of the guide corridor, a width of the guide corridor in a transverse direction transverse to the longitudinal direction being controllable as a function of a diameter of the piece of tubing; and
a support surface arranged downstream of the guide corridor in a conveying movement at least one position in the longitudinal direction, which support surface is configured for aligning the prolate object during insertion into the opened piece of tubing,
wherein the support surface comprises at least two partial surfaces arranged one behind another in the longitudinal direction and overlapping in the transverse direction for supporting the prolate object during insertion.

2. The device of claim 1, wherein a height of the support surface perpendicular to the longitudinal direction and to the transverse direction is dependent on the width of the guide corridor.

3. The device of claim 1, wherein at least one partial surface is rigidly connected to one of two opposite sides of the guide corridor in the transverse direction.

4. The device of claim 1, wherein the support surface comprises at least three partial surfaces,
wherein a first partial surface and a third partial surface are connected to a first side of the guide corridor, and
wherein a second partial surface arranged in the longitudinal direction between the first and third partial surfaces is connected to a second side of the guide corridor opposite the first side.

5. The device of claim 1, wherein the at least two partial surfaces of the support surface arranged one behind another in the longitudinal direction each comprise a concave curvature, and
optionally wherein the concave curvatures of the partial surfaces arranged on opposite sides of the guide corridor are mirrored with respect to an axis perpendicular to the longitudinal direction and transverse direction.

6. The device of claim 1, wherein the guide corridor comprises a carriage movable in the transverse direction on at least one of two opposite sides of the guide corridor.

7. The device of claim 6, wherein the guide corridor comprises a carriage movable in the transverse direction on a first side and is immovable in the transverse direction on a second side opposite the first side, or
wherein the guide corridor comprises two carriages each movable in opposite directions in the transverse direction on the opposite sides of the guide corridor.

8. The device of claim 1, wherein the diameter of the piece of tubing is detected based on a contact pressure of the at least one carriage and/or without contact and/or is transmitted by a printer upstream of the guide corridor in the conveying direction and/or by a control system of the device.

9. The device of claim 1, wherein an overlapping union of the at least two partial surfaces arranged one behind another in the longitudinal direction, which are each coupled to one of the two opposite sides of the guide corridor, form a lower apex of the support surface.

10. The device of claim 1, wherein a slope of the partial surfaces, a curvature of the partial surfaces, a height of the support surface and/or a height of the lower apex comprises a function of the width of the guide corridor, optionally a monotonic function of the width of the guide corridor.

11. The device of claim 1, wherein the support surface is arranged along the longitudinal direction at one end of the guide corridor.

12. The device of claim 1, wherein the support surface is arranged on a housing side of the device,
wherein the housing side is arranged along the longitudinal direction at one end of the guide corridor, and
wherein the housing side comprises an opening for receiving the prolate object into the guide corridor.

13. The device of claim 1, wherein the guide corridor comprises funnel-shaped half-forms on opposite sides in the transverse direction, and
wherein the funnel-shaped half-forms taper in the longitudinal direction from the support surface in a direction towards the guide corridor for insertion of the prolate object into the end opening of the piece of tubing.

14. The device of claim 1, wherein the support surfaces, the partial surfaces, the funnel-shaped half-forms and/or the housing are formed of plastics.

15. The device of claim 1, wherein the guide corridor comprises profiled rollers on opposite sides, and
wherein the profiled rollers are configured to open and/or convey the piece of tubing.

16. The device of claim 14, wherein sensors are arranged along the longitudinal direction between the profiled rollers, which sensors are configured to detect and/or monitor a position of the piece of tubing and/or the prolate object in the guide corridor.

17. The device of claim 1, wherein a side of the device, which side is facing away from the support surface along the longitudinal direction of the guide corridor, is arrangeable on a printer, and
wherein the printer is configured to provide the piece of tubing printed.

18. A system for insertion of a prolate object into a piece of tubing, which is opened at least at the end, optionally a printed piece of tubing, for marking the prolate object, the system comprising:
a printer, optionally a thermal transfer printer, which is configured to output a printed piece of tubing as a printed product; and
the device of claim 1,
wherein the guide corridor is arranged relative to the printer to receive the printed piece of tubing output by the printer as the printed product.

19. A method for insertion of a prolate object in a piece of tubing which is opened at least at the end, optionally a printed piece of tubing, for marking the prolate object, the method comprising:
controlling a width in a transverse direction transverse to a longitudinal direction of a guide corridor depending on a diameter of the piece of tubing;
conveying the piece of tubing in the longitudinal direction of the guide corridor;
supporting the prolate object on a support surface arranged at least one position in the longitudinal direction downstream of the guide corridor in a conveying movement, the support surface comprising at least two partial surfaces arranged one behind another in the longitudinal direction and overlapping in the transverse direction for supporting the prolate object during insertion; and
inserting the prolate object into the end of the piece of tubing on the downstream side of the conveying direction along the support surface.
